(19) United States
(12) Patent Application Publication
(10) Pub. No.: US 2007/0125950 A1
(43) Pub. Date: Jun. 7, 2007

(54) FOURIER TRANSFORM INFRARED SPECTROPHOTOMETER

(76) Inventors: Hai-Shui Wang, Changchun, Julin (CN); Junzo Umemura, Uji, Kyoto-fu (JP)

Correspondence Address: BAKER & DANIELS LLP;111 E. WAYNE STREET, SUITE 800, FORT WAYNE, IN, 46802, US

(21) Appl. No.: 11/548,414

(22) Filed: Oct. 11, 2006

(30) Foreign Application Priority Data
Oct. 14, 2005 (JP) 2005-328062

(51) Int. Cl. G01J 5/02

(52) U.S. Cl. 250/339.08

(57) ABSTRACT

A convenient and economical method and instrumentation to efficiently reduce offensive spectral noises due to water vapor and carbon dioxide gas often encountered in FTIR spectrophotometry is provided by spectrally monitoring and controlling the amount of water vapor and carbon dioxide gas inside the spectrophotometer such that both amounts in the sample and background measurements become congruent through remote open-close operation of water-vapor (or carbon dioxide gas) supplier and dehumidifier (or carbon dioxide gas adsorber). This new technique can be used: (1) Under the ambient humidity condition, saving time and money effectively. (2) Both in the closed spectrophotometer and in the open system. (3) And applicable to any FTIR accessory and measurement method, including transmission, external reflection, reflection-absorption, attenuated total reflection (ATR), and microscopy measurements.

### CROSS-REFERENCE TO RELATED APPLICATIONS

The present application claims the priority of JP 2005-328062, filed in Japan on Oct. 17, 2005, the entire contents of which are incorporated herein by reference.

### BACKGROUND OF THE INVENTION

1. Field of the Invention

The present invention relates to a technique to reduce spectral noises due to water vapor or carbon dioxide gas often found in Fourier transform infrared (FTIR) spectrophotometry.

2. Description of Related Art

Spectral noises due to water vapor or carbon dioxide gas in the air often disturb FTIR spectroscopic analysis of materials. Normally, to obtain IR spectra (transmittance or reflectivity plotted against wavenumbers per cm; wavenumber region is between near and far IR, 12000-10 cm⁻¹), the background FTIR spectral intensity I_{B} without any sample and the sample FTIR spectral intensity I_{S} with a sample are separately measured by multiple scanning, and its ratio T=I_{S}/I_{B} is plotted against wavenumbers. Instead of T, transmission or reflection absorbance A=−logT can be plotted against wavenumbers. Under the circumstances, water vapor and carbon dioxide gas which give continuous fine structures in IR spectra exist in the optical path from the IR source to the detector, and their concentrations vary between I_{B} and I_{S} measurements. Thus, they appear as spectral noises against sample bands. To reduce or remove these noises, the following methods have heretofore been proposed.
(1) The method to remove water vapor and carbon dioxide gas by vacuum-pumping the closed FTIR spectrophotometer.
(2) The method to reduce water vapor by putting desiccant agents in the closed FTIR spectrophotometer. In connection with this, methods have been proposed to use source heat for recycling the desiccant agents [1] as well as to use peltiert device to expel water vapor out of instruments [2].
(3) The method to reduce water vapor and carbon dioxide gas by purging the closed FTIR spectrophotometer with nitrogen gas or dry air.
(4) In connection with the method (3), the technique to use automatically computer-controlled valves for the open-close operation of purging [3].
(5) The polarization modulation method to use the IR beam with periodically changing polarization direction which is incident upon the surface of metals or molecules adsorbed on the water surface. In this case, reflection spectra are obtained by computing the ratio of the difference to sum values. Spectral noises by water vapor and carbon dioxide gas can be removed during the computation.
(6) The method to use a shuttle system where the sample is repeatedly moved in and out from the IR beam in some short period, thus the amounts of water vapor and carbon dioxide gas are equilibrated between I_{B} and I_{S} measurements during multiple accumulations.
(7) Standard spectra of water vapor or carbon dioxide gas are measured in advance, and they are added or subtracted from the IR spectrum of sample to reduce spectral noises.
(8) The multivariable analysis for the standardization method of spectrophotometers [4,5] is applied to high resolution spectral data base HITRAN [6] of water vapor and carbon dioxide gas measured at different temperatures to automatically reduce spectral noises by computations [7].
[1] JP1988-25345A
[2] JP2004-108970A
[3] JP1993-288606A
[4] U.S. Pat. No. 6,049,762
[5] JP1994-167445A
[6] L. S. Rothman et al., “The HITRAN 2004 molecular spectroscopic database”, J. Quant. Spectrosc. Radiat. Trans., 96 (2), 139-204 (2005).
[7] E. Sato, K. Haraguchi, N. Onda, and M. Morimoto, “Some Application of New Elimination Technique of Water Vapor and CO₂ Absorption on FT-IR”, Fourier Transform Spectroscopy: Twelfth International Conference, K. Ito and M. Tasumi Ed., Waseda University Press, 1999, pp.197-198.

### SUMMARY

As stated, eight methods have been proposed, but these methods have various disadvantages from the point of view of their aimed performance as well as cost performance. Thus, enough room is left for improvement. For example, to vacuum-evacuate the closed spectrophotometer in Method (1), we need a vacuum-pump and a spectrophotometer package endurable to pressure deformations. The evacuation is a time consuming process, and we need to pay much attention not to loose sample by evacuation. In Methods (1)˜(3), we need a sufficient time to evacuate, to be adsorbed by desiccant agents, or to exchange the atmosphere by dry air or nitrogen supply after sample change. In Methods (2) and (3), depending upon peak absorbance values of a sample, we often need 10 to 30 minutes to reduce the water vapor level tolerable to IR measurements. Also in Method (3), nitrogen gas or dry air supply is a costly process. Method (4) is suitable for gas measurements but is not necessarily so in liquid or solid samples from its configuration. The method (5) can be applicable only for special reflection measurements. In (6), we need time to shuttle movements, and accordingly measurement time is increased. Transmission measurements are suitable, while reflection measurements which need precise alignments of reflection attachments are not. Also, in (7) perfect removal of spectral noise is difficult, because peak position, intensity and band shape of gas spectra are dependent on temperature, concentration (humidity), and pressure. Actual gas phase spectra are never be the same with a standard spectrum. Moreover, in Method (8), the measured intensity and band shift is analyzed by multivariable analysis to obtain a theoretical spectrum and then it is subtracted from the measured spectrum. However, the theoretical spectrum is all just approximate, so that the method has its own limitation when the spectral intensity of a sample is weak.

Thus, the present invention is intended to reduce above problems and supply a superior FTIR spectrophotometer free from spectral noises due to water vapor and carbon dioxide gas in terms of its convenience and cost performance.

To solve above problems, the concentration of water vapor or carbon dioxide gas is monitored during the background and sample measurements in this invention. This can be performed easily by the real time display of each FTIR spectrum during each scan of multi-scanning in modern conventional FTIR spectrophotometers.

In this invention, a characteristic FTIR spectrophotometer is constructed such that the open-close movement of doors of a vessel with wetting agent or that with desiccant agent is remotely controlled to equilibrate the amount of water vapor in the sample and background spectra, thus reducing the spectral noises. The remote control is important because FTIR spectrophotometers dislike shocks or vibrations from out side.

The FTIR spectrophotometer is characteristically constructed such that the above wetting and drying are accomplished by supplying humid air and dry air (nitrogen gas) from humidifier and dehumidifier, respectively.

In this invention, an FTIR spectrophotometer is also constructed such that the amount of carbon dioxide gas in the background and sample measurements are equilibrated using carbon dioxide supplier and adsorbent, thus reducing spectral noises.

According to the Invention, the amount of water vapor and carbon dioxide gas in the optical path is actively increased or decreased by monitoring them on a computer display or by computer-controlled automatic program during the FTIR analysis. Therefore, these amounts in the sample and background scans can be kept equal, so that the spectral noises due to water vapor and carbon dioxide gas can be minimized. Since these methods themselves can be applied under the normal humidity or room atmosphere, time and cost needed for evacuation or purging in the traditional methods (1), (3), or (4) can enormously be reduced. This new method is completely different from the traditional methods in that the former methods passively wait until the water vapor or carbon dioxide gas concentration reaches a tolerate level before background and sample measurements but the new method actively control the gas concentration during a sample measurement to the value in a background measurement irrespective of its concentration level. Thus, the waiting time after breaking the closed system is unnecessary, improving the efficiency of rapid analysis quite a lot. No one ever comes up with this innovative idea during the 30 years-long history of FTIR spectroscopy. One of the reason is that to add humid air into the FTIR spectrophotometer was a taboo in IR spectroscopy where hygroscopic materials has been used for windows and so forth for a long time instead of recently employed anti-hygroscopic materials.

### BRIEF DESCRIPTION OF THE DRAWINGS

FIG. 1 is a schematic top view of the FTIR spectrophotometer to show embodiment of the present invention. Here, numeral 1 denotes room, 2 outer wall, 3 partition wall, 4 sample room, 5 sample, 6 and 7 IR transmitting windows, 8 source, 9 fixed mirror, 10 beam splitter, 11 fixed mirror, 12 moving mirror, 13 and 14 fixed mirrors, 15 detector, 16 computer, 17 vessel, 18 vessel, 19, 20 and 21 computer controllable open-close doors, 22 heater, 23 water pool, 24 and 25 pipes.

FIG. 2(A) is the FTIR spectrum of a thin casted film of stearic acid measured immediately after sample exchange without opening doors 19 and 21, corresponding to the spectrum measured by a prior art spectrophotometer (Bruker Model VERTEX 70 spectrophotometer) non-equipped with drying and humidifying agents.

FIG. 2(B) is the FTIR spectrum of a thin cast film of stearic acid measured using this innovative spectrophotometer.

FIG. 3(A) is the FTIR spectrum in the region of water vapor without any sample for two single beam spectra I_{B} and I_{S} respectively measured before and after an open-close operation of a lid covering the whole top part of the sample room 4, corresponding to a situation often met during sample exchange in a prior art spectrophotometer.

FIG. 3(B) is the FTIR spectrum in the region of water vapor without any sample for two single beam spectra I_{B} and I_{S} respectively measured before and after an open-close operation of a lid of the sample room, using this innovative spectrophotometer.

FIG. 4(A) shows an FTIR spectrum without any sample in the region of water vapor for two single beam spectra I_{B} and I_{S}. Here, I_{S} contained less water vapor than I_{B}, showing negative absorbances in all of the water bands.

FIG. 4(B) represents the corresponding spectrum measured using the humidifying mode of this innovative spectrophotometer.

### DETAILED DESCRIPTION OF THE PREFERRED EMBODIMENTS

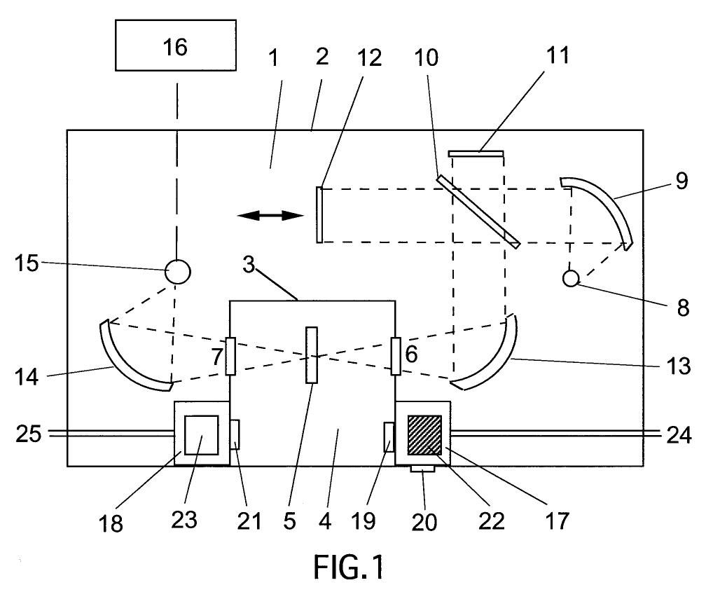

The embodiment of this invention is explained below, based on the drawings. The illustrative embodiment of Invention 1 is shown in FIG. 1. This figure schematically illustrates the configuration of the FTIR spectrophotometer concerning the invention. Herein, 1 is the spectrophotometer housing (Room 1) which is closed and separated from the exterior by Outer Wall 2. Part of Room 1 is divided into Room 4 by Partition Wall 3. Room 4 is a sample room where Sample 5 is placed, and the whole top part of Room 4 is a lid to exchange samples. In two parts 6 and 7 of Partition Wall 3, attached are IR transmitting Windows 6 and 7 through which the IR beam passes. In Room 1, the IR beam which is emitted from Source 8 is collimated by Mirror 9 and partly reflected by Beam Splitter 10 of the interferometer and reaches Fixed Mirror 11 while the remaining beam is partly passes through Beam Splitter 10 and reaches Moving Mirror 12. Two beams reflected by Mirrors 11 and 12 are combined into one beam by Beam Splitter 10 and reach Mirror 13 after which it passes through Window 6, Sample 5, and Window 7. Then, it is converged into Detector 15 by Mirror 14. The detector changes the IR intensity into an electric signal and it is introduced into Computer 16 where an interferogram which is the distribution of light intensity versus the retardation of the moving mirror is Fourier transformed into a spectrum which is the light intensity distribution versus wavenumber.

Vessels 17 and 18 adjacent to Room 4 respectively contain drying and humidifying agents which concern the present invention. Computer controlled Open-Close Doors 19 and 20 are attached to Vessel 17 where drying agents typified by silica gel is placed on Electric Heater 22. Water Pool 23 is equipped in Vessel 18 from which water vapor is supplied to the inside of Room 4 through automatic Open-Close Door 21.

In concrete terms, I_{B} is measured without any sample. Next, I_{S} is measured with a sample. The number of scans must be increased if the signal intensity of the sample is weak. When summed spectra whose ordinates are absorbances are displayed during each scan, upward peaks appear in particular abscissa positions of wavenumber. The more strongly the sample absorbs, the larger the peak height becomes. Concerning water vapor peaks, upward peaks appear if I_{S} contains more water vapor than I_{B}, while downward peaks appear if I_{S} contains less water vapor than I_{B}. Since many water peaks appear, we can select a strong peak different from sample peaks to monitor the amount of water vapor. By the sign and height of the peak, the relative amount of water vapor in I_{S} to I_{B} can be judged.

Thus, if the amount of water vapor in I_{S} is more than I_{B} during I_{S} measurement, we can send a message to Computer 16 (or alternatively by the computer itself following the pre-programmed mode) to open Door 19 for reduction of water vapor amount. After opening the door, the amount of water vapor in the optical path starts to decrease by adsorption, and so upward peaks of water vapor will become smaller and smaller with the increase in scanning number or time, until they become unobservable when the amount of water vapor in I_{S} is equal to that in I_{B}. On the contrary, if the amount of water vapor in I_{S} is less than I_{B}, peaks appear downwards and so we can open Door 21 to supply water vapor into Room 4. The open-close operation of the door is achieved by a direct-current motor with a positive or negative current sent from the computer out-put which is generally equipped in modern FTIR spectrophotometers. We (or the computer) can close the door (or stop the collection of the spectrum) when the absolute value of the peak absorbance becomes less than the preset value. Then, the peak height of the water vapor can be controlled to be less than the preset value, meaning the spectral noises due to water vapor can be reduced to such an amount as we can select. Thus, we can get a water vapor noise-free spectrum of the sample during the accumulation of the spectrum. In some occasional cases, over-shooting to a different sign direction of absorbance may occur by too fast drying or humidification. In such circumstances, pre-stopping control of Doors 19 or 21 can be achieved by measuring the speed of drying or humidification. Even if overshoot occurs, readjustment can be performed by close-open operations of Doors 19 and 21.

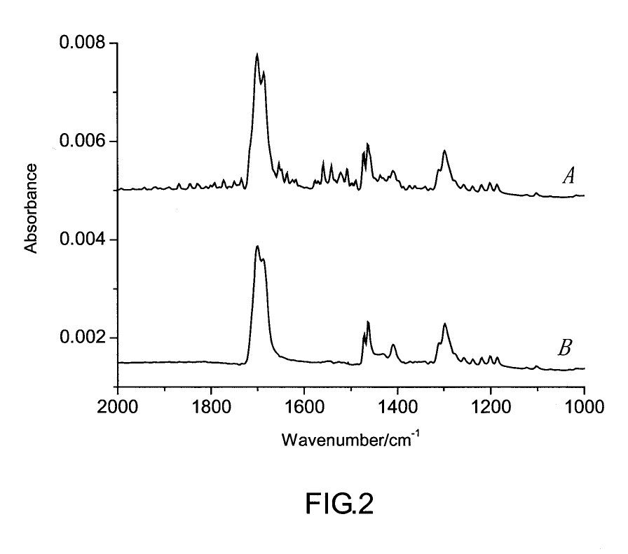

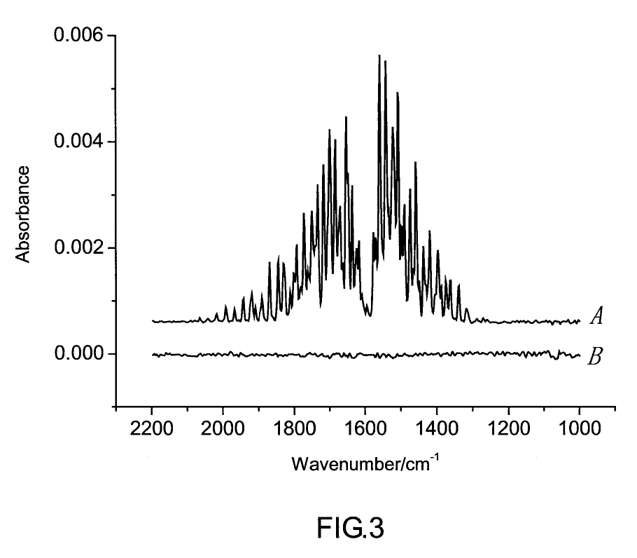

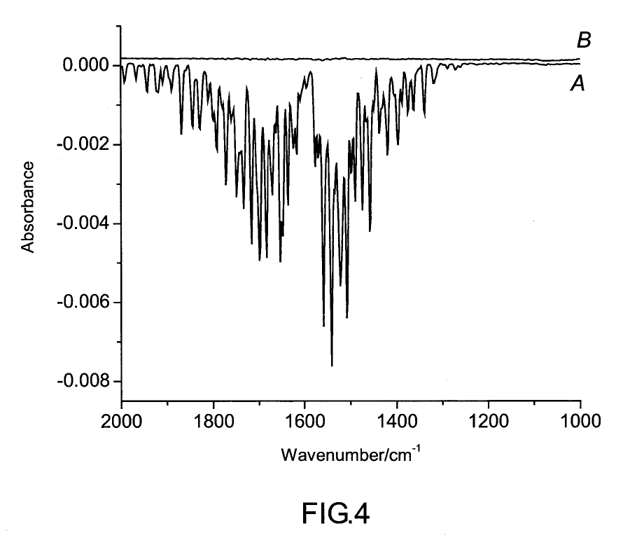

FTIR spectra were measured using a spectrophotometer based on a Bruker Model VERTEX 70 equipped with a D-LaTGS detector. Spectral Resolution was 4 cm⁻¹ with zero-filling factor of 2, and the scanning number was around 200. An apodization function of Blackman-Harris 3-Term was used. An ultra-thin cast film of stearic acid having a thickness of several monolayers was prepared from a 1.0×10⁻³ M chloroform solution of stearic acid on a CaF₂ plate. The sample room of this spectrophotometer is separated by KBr windows from the main compartment of the spectrophotometer. The relative humidity and temperature of the laboratory was around 60% and 20° C. The drying agent contained in Vessel 17 was about 200 g of silica gel. FIG. 2(A) shows an FTIR spectrum of a thin cast film of stearic acid measured immediately after sample exchange without opening Doors 19 and 21 of this apparatus. Here, I_{S} was measured after a few minutes' opening of the lid of the sample room. Noises due to water vapor are large. FIG. 2(B) demonstrates an FTIR spectrum of the same sample measured by this apparatus. In this case, the control of humidifying or drying as well as the stop operation of the measurement was performed by visual observation of the live computer display at each scan. The effect of noise reduction around 1600 cm⁻¹ is prominent during the measurement time of only 3.5 minutes. FIG. 3(A) shows an FTIR spectrum without any sample in the region of water vapor for two single beam spectra I_{B} and I_{S} respectively measured before and after a short open-close operation of a lid of the sample room. The sample room of the spectrophotometer had been dried with silica gel before opening the lid. FIG. 3(B) represents the corresponding spectrum measured using the apparatus. Spectral noises due to water vapor are reduced to such a level of that inherent to the spectrophotometer itself during the scan, as is revealed by those below 1300 cm⁻¹. FIG. 4(A) shows an FTIR spectrum without any sample in the region of water vapor for two single beam spectra I_{B} and I_{S} During the background scan, the sample room of the spectrophotometer had not been well dried with silica gel unlike the initial sample scan, so that the peak absorbances of water bands are all negative. FIG. 4(B) represents the corresponding spectrum measured using the humidifying mode of this apparatus. Spectral noises due to water vapor are completely removed during the scanning time of 3.5 minutes. We made many experiments and similar satisfactory results could be obtained in either case of drying or humidifying modes.

Vessels 17 and 18 can be equipped with Pipes 24 and 25, respectively. From 24, low humidity gas such as dry air or nitrogen gas can additionally be supplied, while from 25, room air or humidified air can be supplied.

The FTIR spectrophotometer is designed as such that the dehumidification and humidification are performed only by low humid gas from Pipe 24 and humid gas from Pipe 25.

In another embodiment of this Invention, the FTIR spectrophotometer is designed as such that to reduce noises due to carbon dioxide gas, instead of drying agents or dry air in Vessel 17 or Pipe 24, respectively, carbon dioxide absorbing agents (like Na-X type zeolites) or carbon dioxide-free gases are used to equilibrate the amount of carbon dioxide gas in both sample and background measurements. Also, in Vessel 18 or Pipe 25, instead of humidifying agents or humid air, carbon dioxide supplying agents or supplier, respectively, are supposed to be used.

In the embodiment of FIG. 1, Drying or Humidifying Vessels 17 or 18 are arranged next to Room 4, so that supply of drying agent or water is easy for replacements from the sample room side. Further, if we connect a large siphon tank to 23, water supply can be maintained for a long period. Also, if we put on Heater 22 up to a temperature around 120° C. and open Door 20 during night or leisure time, the adsorbed water onto drying agent can be repelled outside. The replacement of the agent can be prolonged with less maintenance. Since the control of water vapor quantity is achieved within Room 4, the amount of water vapor to be supplied or removed can be limited to a minimum.

In the embodiment of FIG. 1, Drying or Humidifying Vessels 17 or 18 are arranged next to room 4. But in another embodiment, they can be placed inside Room 4 with more compact sizes. In this case, Door 20 can be placed on top of Vessel 17 to release water vapor from inside Room 4. In these embodiments including that of FIG. 1, the distance between water vapor supply and Windows 6 or 7 is so close that it is recommended to use anti-hygroscopic windows such as KRS-5 or polyethylene (in case of far infrared). By the way, Windows 6 and 7 are attached to keep Room 1 as dry as possible, separating it from Room 4 which is exposed to outer atmosphere during sample exchange. Under the principle of this invention, the noise level due to water vapor is not dependent on its own amount, but on its difference between I_{B} and I_{S}, and we can always make it equilibrated with each other, so that those windows are not necessarily needed. In recent FTIR spectrophotometers, since the surface of a beam splitter is coated with anti-hygroscopic materials, and anti-hygroscopic windows like KRS-5 are used to protect detectors, window-less FTIR spectrophotometers can be used under the ambient humidity condition. In that sense, Vessels 17 and 18 can be placed in anywhere inside or outside the spectrophotometer near the optical path. But, if the drying or humidifying capacity is concerned, small space is preferred to control more efficiently. The small room separated by two windows (which is not limited to the sample room) can be placed in any part of the optical path of the spectrophotometer.

In the embodiment of FIG. 1, only noise due to either water vapor or carbon dioxide gas is intended to remove, but if necessary further two vessels can be placed besides Vessels 17 and 18, as well as two other pipes besides Pipes 24 and 25. By doing so, we can remove both noises due to water vapor and carbon dioxide gas simultaneously during spectral accumulation.

Further, hitherto it has been explained that background I_{B} is first measured and the sample I_{S} is next measured, during which the amount of water vapor or carbon dioxide gas is controlled. However, this sequence can be changed such that I_{S} is first measured and then I_{B} is measured during which the control of vapor or gas amount is achieved.

It should be noted that this technique is applicable to any FTIR accessory and method such as transmission, external reflection, reflection-absorbance, attenuated total reflection (ATR), and microscopy measurements.

What is claimed is:

1. A Fourier transform infrared spectrophotometer to reduce spectral noises due to water vapor, comprising:
a sample room in which a sample is placed,
a humidifying vessel containing a humidifying agent, which humidifies the inside of the sample room through a first door isolating the vessel and the sample room, and
a drying vessel containing a dehumidifying agent, which dehumidifies the inside of the sample room through a second door isolating the vessel and the sample room;
whereby the first door and the second door are opened or closed to make the difference of IR peak intensity of water vapor smaller than a prescribed value between spectra measured by placing and removing the sample in the sample room.

2. The Fourier transform infrared spectrophotometer according to claim 1, wherein the humidifying vessel and the drying vessel are placed outside of the spectrophotometer and attached to the sample room through the first door and the second door, respectively.

3. The Fourier transform infrared spectrophotometer according to claim 1, wherein the humidifying vessel and the drying vessel are arranged inside the sample room.

4. The Fourier transform infrared spectrophotometer of claim 1, wherein the drying vessel is connected to a dry gas source.

5. The Fourier transform infrared spectrophotometer of claim 1, wherein the ambient atmosphere is introduced into the humidifying vessel.

6. A Fourier transform infrared spectrophotometer to reduce spectral noises due to carbon dioxide gas, comprising:
a sample room in which a sample is placed,
a vessel containing a carbon dioxide gas supplier, which increases carbon dioxide concentration of the sample room through a first door isolating the vessel and the sample room, and
a vessel containing a carbon dioxide adsorber, which decreases carbon dioxide concentration of the sample room through a second door isolating the vessel and the sample room;
whereby the first door and the second door are opened or closed to make the difference of IR peak intensity of carbon dioxide gas smaller than a prescribed value between spectra measured by placing and removing the sample in the sample room.

7. The Fourier transform infrared spectrophotometer according to claim 6, wherein the carbon dioxide supplying vessel and the carbon dioxide adsorbing vessel are placed outside of the spectrophotometer and attached to the sample room through the first and second doors, respectively.

8. The Fourier transform infrared spectrophotometer according to claim 6, wherein the carbon dioxide supplying and adsorbing vessels are arranged inside the sample room.

9. The Fourier transform infrared spectrophotometer of claim 6, wherein the carbon dioxide supplying vessel is connected to an outer gas source.

10. The Fourier transform infrared spectrophotometer according to claim 1, wherein a humidity control room which has two optical windows and is connected to the humidifying and drying vessels is added somewhere in the optical path, instead of controlling the humidity of the sample room.

11. The Fourier transform infrared spectrophotometer according to claim 10, wherein the humidifying vessel and the drying vessel are placed outside of the spectrophotometer and attached to the humidity control room through the first and second doors, respectively.

12. The Fourier transform infrared spectrophotometer according to claim 10, wherein the humidifying and drying vessels are respectively arranged inside the humidity control room.

13. The Fourier transform infrared spectrophotometer of claim 10, wherein the drying vessel is connected to a dry gas source.

14. The Fourier transform infrared spectrophotometer of claim 10, wherein the ambient atmosphere is introduced into the humidifying vessel.

15. The Fourier transform infrared spectrophotometer according to claim 6, wherein a CO₂-concentration control room which has two optical windows and is connected to the carbon dioxide supplying and adsorbing vessels is added somewhere in the optical path, instead of controlling the CO₂-concentration of the sample room.

16. The Fourier transform infrared spectrophotometer according to claim 15, wherein the carbon dioxide supplying vessel and the carbon dioxide adsorbing vessel are placed outside of the spectrophotometer and attached to the CO₂-concentration control room through the first and second doors, respectively.

17. The Fourier transform infrared spectrophotometer according to claim 15, wherein the carbon dioxide supplying and adsorbing vessels are arranged inside the CO₂-concentration control room.

18. The Fourier transform infrared spectrophotometer of claim 15, wherein the carbon dioxide supplying vessel is connected to an outer gas source.
